(19) United States
(12) Patent Application Publication
(10) Pub. No.: US 2007/0268950 A1
(43) Pub. Date: Nov. 22, 2007

(54) Low power Q-switched solid-state lasers

(76) Inventors: Luis A. Spinelli, Sunnyvale, CA (US); Andrea Caprara, Mountain View, CA (US); John H. Jerman, Palo Alto, CA (US)

Correspondence Address: STALLMAN & POLLOCK LLP, 353 SACRAMENTO STREET, SUITE 2200, SAN FRANCISCO, CA, 94111, US

(21) Appl. No.: 11/434,624

(22) Filed: May 16, 2006

(51) Int. Cl. H01S 3/093; H01S 3/08

(52) U.S. Cl. 372/99; 372/72; 372/107

(57) ABSTRACT

In a miniature Q-switched, pulsed laser, having a two arm folded resonator, Q-switching is effected by rapidly and reciprocally tilting a resonator mirror of the laser about an axis perpendicular to the axis of the laser resonator. The angular excursion of the tilting and the frequency of the tilting are selected cooperative with dimensions of the resonator to maximize energy and symmetry of intensity distribution in Q-switched pulses delivered by the laser. Rapid reciprocal tilting of the mirror is accomplished using a piezoelectrically-driven, MEMS scanner operated in a resonant mode.

### TECHNICAL FIELD OF THE INVENTION

The present invention relates in general to Q-switched pulsed lasers. The invention relates in particular to Q-switched pulsed lasers in which Q-switching is accomplished by a scanning resonator mirror.

### DISCUSSION OF BACKGROUND ART

Pulsed Q-switched lasers are used in a variety of laser machining operations including cutting, drilling, routing, and marking of hard materials. The Q-switching principle involves locating an optical switch in a laser resonator. When the optical switch is in a “closed” mode, lasing action in the resonator is delayed until a gain-medium of the resonator has been energized, usually by optical pumping, for a time sufficient that energy stored in the gain-medium is close to, or at, a maximum possible (saturated) value. When the switch is “opened”, lasing action builds up in the resonator and the stored energy is released as a pulse. If the gain-medium is continuously pumped, the optical switch can be closed and opened periodically to provide periodically repeated pulses at a pulse repetition frequency usually abbreviated by practitioners of the art as the PRF. If, at the highest PRF, the time period between pulses is more than the time required to reach saturation of the gain-medium, pulse energy will be independent of PRF. If this is not the case, pulse energy will be inversely dependent on PRF over some range of PRF.

An optical switch commonly used in Q-switched pulsed lasers is an acousto-optical switch (AO-switch). Such a switch consists of an optical element that has a periodic refractive-index variation induced therein by applying a high radio-frequency (RF) potential to piezoelectric element attached thereto. In a common mode of operation, the optical element, having the RF potential applied thereacross, has periodic refractive index differences induced therein, thereby behaving as a weak diffraction grating, and deflecting sufficient energy out of the resonator that lasing action in the resonator is not possible. In this condition, the AO-switch is in a “closed” mode. When the potential is switched off, the induced diffraction disappears, the AO-switch is in an “open” mode, and does not deflect any energy out of the resonator, thereby allowing the build-up of laser energy in the resonator and the release of a high-power laser-pulse. The laser pulse can be focused to provide a light-intensity sufficient to ablate refractory metals and dielectrics.

Such prior-art high-power Q-switched pulsed-lasers are sufficiently expensive and bulky that their use is limited to commercial and industrial applications. It is believed that there are several possible small craft-applications and household-applications for laser marking and engraving where a Q-switched laser having less power than present industrial lasers would be useful. Such a laser would need to be relatively inexpensive, for example, have a price comparable at least to the price of professional grade electrical power tools. Preferably the laser would be sufficiently small to be hand-held.

One step in reducing the cost of a Q-switched laser would be to replace the AO-switch, and the RF power supply associated therewith, with a simpler switch. In early prior-art documents it is suggested that Q-switching can be accomplished by making one mirror of a laser resonator a facet of a multi-faceted rotating wheel. It is taught that as each facet of the wheel rotates through the resonator axis will be a sufficiently brief period where the resonator is aligned and laser action can occur, thereby accomplishing Q-switching.

Even though this teaching has been available to practitioners of the art for several years, it is not believed that a rotating faceted mirror or any rotating mirror has been incorporated as a Q-switch in any commercially available laser. There are several possible reasons for this. One possible reason is that there does not appear to be any teaching that would indicate what the pulse characteristics would be from a resonator that is arguably misaligned during some portion of a pulse duration. Another possible reason is that such a rotating device would need an electric motor for driving the device, and with sufficient precision that a consistent pulse-repetition frequency and pulse characteristics could be held reasonable constant. Further, each facet of such a rotating faceted device would need to be individually polished and optically coated, which is inconsistent with usual requirements for low-cost production.

It seems that if a commercially viable Q-switched laser is to be made without an electro-optical Q-switch, there is need for a low-cost alternative to the earlier-suggested rotating faceted mirror to provide a mechanical Q-switch. Further, there is a need to investigate limits within which such a mechanical Q-switch can function, while still providing the pulse characteristics and beam quality of prior-art electro-optically Q-switched lasers in which resonators are fixedly aligned.

### SUMMARY OF THE INVENTION

The present invention is directed to providing a pulsed Q-switched that does not include an acousto-optical Q-switch. In one aspect, a laser in accordance with the present invention comprises a laser resonator having a longitudinal axis and a resonator mode. A solid-state gain-medium is located in the laser resonator. An arrangement is provided for optically pumping the gain-medium with a beam of pump-light delivered thereto along the longitudinal axis of the laser resonator, thereby creating an excited volume in the gain-medium. The laser resonator includes a mirror located on the longitudinal axis of the laser resonator and periodically reciprocally tiltable about at least one axis transverse thereto. The mirror is periodically reciprocally tilted in a manner such that the resonator mode is swept through the excited volume in the gain-medium at least once during a fraction of a tilt period of the mirror.

In a preferred embodiment of the laser the tiltable mirror is an end mirror of the laser resonator. Another end mirror of the laser resonator may be digitally tilted from an orientation in which laser pulses are generated by sweeping the mode through the excited volume of the gain-medium to an orientation that prevents generation of pulses in any orientation of the periodically tilted mirror. This can be used to cause the laser to deliver bursts of pulses or individual pulses at intervals therebetween which are integer multiples of half of the oscillation period of the periodically tiltable mirror.

In another aspect of the present invention, the periodically reciprocally tiltable mirror is preferably driven by an inventive MEMS (micro electromechanical system) scanner operated in a resonant mode. The inventive scanner can be manufactured in high volume at relatively low cost using photolithographic etching to define metal components of the scanner.

### BRIEF DESCRIPTION OF THE DRAWINGS

The accompanying drawings, which are incorporated in and constitute a part of the specification, schematically illustrate a preferred embodiment of the present invention, and together with the general description given above and the detailed description of the preferred embodiment given below, serve to explain principles of the present invention.

FIG. 1 schematically illustrates a basic prior-art resonator suitable for Q-switched operation, the resonator being a hemi-confocal resonator including a plane, maximum-reflecting mirror, and a concave output-coupling mirror, with a gain-medium located adjacent the flat mirror, the pulse delivery characteristics of which resonator are used for comparison with calculated pulse characteristics of one basic embodiment of laser-resonator in accordance with the present invention.

FIG. 2 is a graph schematically illustrating calculated pulse-power characteristics and stored energy in the gain-medium as a function of time in the prior-art laser-resonator of FIG. 1.

FIG. 3 schematically illustrates a basic embodiment of a laser resonator in accordance with the present invention similar to the laser resonator of FIG. 1 but wherein the concave output-coupling mirror is periodically reciprocally tilted about an axis transverse to the longitudinal axis of the laser resonator, through a range of angles about a position of perfect alignment with the plane mirror.

FIG. 4 is a graph schematically illustrating deflection angle as function of time for a full reciprocal tilt period of the concave mirror of FIG. 4, the maximum tilt angle and period of oscillation being selected, corresponding to dimensions of an optical pump beam in the gain-medium, such that the variation of tilt angle as a function of time through perfect alignment will provide output pulses having the characteristics of the output pulse of FIG. 2.

FIG. 4A is a graph schematically illustrating deflection angle as function of time for a fraction of the reciprocal tilt period of the concave mirror of FIG. 4 during which the concave mirror is sufficiently aligned with the plane mirror to permit laser action in the resonator.

FIG. 5 is a graph schematically illustrating calculated pulse-power characteristics and stored energy in the gain-medium as a function of time in the inventive laser-resonator of FIG. 3 in which the concave mirror is periodically reciprocally tilted under the optimized maximum tilt angle and oscillation frequency parameters of FIGS. 4 and 4A.

FIG. 6 is a graph schematically illustrating calculated variation of the beam centroid position of the pulse of FIG. 5 as a function of time on the plane mirror of the resonator during evolution of the pulse.

FIG. 7 is a graph schematically illustrating calculated pulse-power characteristics and stored energy in the gain-medium as a function of time in the inventive laser-resonator of FIG. 3 in which the concave mirror is periodically reciprocally tilted through one-half of the optimized maximum tilt angle of FIG. 4 at the same oscillation frequency.

FIG. 8 is a graph schematically illustrating calculated pulse-power characteristics and stored energy in the gain-medium as a function of time in the inventive laser-resonator of FIG. 3 in which the concave mirror is periodically reciprocally tilted through twice the optimized maximum tilt angle of FIG. 4 at the same oscillation frequency.

FIG. 9 is a graph schematically illustrating calculated intensity as a function of X and Y transverse-axis dimensions of the pulse of FIG. 4 in the near-field of the beam.

FIG. 9A is a graph schematically illustrating calculated intensity as a function of X-axis and Y-axis beam divergence angle of the pulse of FIG. 4 in the far-field of the beam.

FIG. 10A is a graph schematically illustrating calculated intensity as a function of X-axis and Y-axis dimensions in the near-field of the beam for the pulse of FIG. 7 in one deflection direction of the concave mirror of FIG. 3.

FIG. 10B is a graph schematically illustrating calculated intensity as a function of X-axis and Y-axis dimensions in the near-field of the beam for the pulse of FIG. 7 in the opposite deflection direction of the concave mirror of FIG. 3.

FIG. 10C is a graph schematically illustrating calculated time-averaged intensity as a function of X-axis and Y-axis dimensions in the near-field of the beam for a repeated sequence of pulses of FIG. 7.

FIG. 10D is a graph schematically illustrating calculated time-averaged intensity as a function of X-axis and Y-axis beam divergence angles in the far-field of the beam for a repeated sequence of pulses of FIG. 7.

FIG. 11 schematically illustrates one preferred embodiment of a MEMS (micro electromechanical system) scanner in accordance with the present invention configured for periodically reciprocally tilting a laser-resonator mirror about a single axis of rotation, the scanner including a metal frame supporting elongated actuator arms coupled to a mirror holder via coupling members, the mirror holder having the mirror attached thereto and being supported in the frame by a torsion bar, and the actuators being periodically deflected by piezoelectric elements attached thereto.

FIG. 11A schematically illustrates the frame, actuator arms, mirror holder, torsion bar, and coupling beams of the scanner of FIG. 11 with the mirror and piezoelectric elements removed.

FIG. 12 schematically illustrates one preferred embodiment of a Q-switched pulsed laser in accordance with the present invention including a two-arm laser resonator terminated by plane mirrors and in which one of the plane mirrors is periodically reciprocally tilted about an axis transverse to the longitudinal axis of the laser resonator by a scanner of the type depicted in FIGS. 11 and 11 A.

FIG. 13 schematically illustrates another preferred embodiment of a Q-switched pulsed laser in accordance with the present invention including a two-arm folded laser resonator terminated by plane mirrors and in which one of the plane mirrors is periodically reciprocally tilted about an axis transverse to the longitudinal axis of the laser resonator by a scanner of the type depicted in FIGS. 11 and 11A, and the other is digitally or discretely tilted from one orientation to another for delivering bursts of Q-switched pulses or discrete Q-switched pulses.

FIGS. 14A-E are timing graphs schematically illustrating an operating mode of the laser of FIG. 13 in which a burst of four pulses is generated followed by an individual pulse and two bursts of two pulses.

FIG. 15 schematically illustrates yet another preferred embodiment of a Q-switched pulsed laser in accordance with the present invention including a three-arm folded laser resonator terminated by two plane end mirrors, and folded by two plane fold mirrors, and in which one of the plane fold mirrors is periodically reciprocally tilted about an axis transverse to the longitudinal axis of the laser resonator by a scanner of the type depicted in FIGS. 11 and 11A, and one of the plane end mirrors is digitally or discretely tilted from one orientation to another for delivering bursts of Q-switched pulses or discrete Q-switched pulses.

FIG. 16 schematically illustrates another preferred embodiment of a MEMS scanner in accordance with the present invention configured for periodically reciprocally tilting a laser-resonator mirror, similar to the scanner of FIG. 11 but wherein the actuators are periodically deflected by electrostatic or magnetic attraction.

FIG. 17 schematically illustrates yet another preferred embodiment of a MEMS scanner in accordance with the present invention configured for moving mirror in a plurality of degrees of freedom, the scanner including three actuators deflected by piezoelectric elements attached thereto, the actuators being coupled to a triangular mirror holder via U-shaped coupling members, the mirror holder having the mirror attached thereto.

FIG. 18 is a three-dimensional view schematically illustrating another basic embodiment of a Q-switched pulsed laser in accordance with the present invention, similar to the laser of FIG. 3, but wherein the reciprocally tilted mirror is replaced by a mirror tiltable in two mutually perpendicular axis such that the axis of the mirror, remote from the mirror, describes a closed loop that intersects the longitudinal axis of the resonator adjacent the optically pumped volume of the gain medium.

FIG. 19 is a three-dimensional view schematically illustrating yet another basic embodiment of a Q-switched pulsed laser in accordance with the present invention, similar to the laser of FIG. 18, but wherein the gain-medium is transversely optically pumped over the entire volume of the gain-medium and wherein a blocking disc having a circular aperture therein limits the access of the lasing mode of the resonator to a volume of the gain-medium having about the same diameter as the lasing mode.

### DETAILED DESCRIPTION OF THE INVENTION

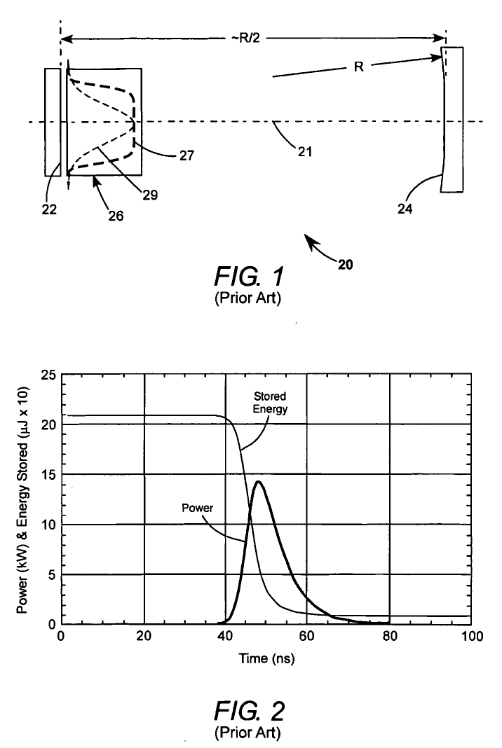

Referring now to the drawings, wherein like components are designated by like reference numerals, FIG. 1 schematically illustrates a hypothetical, basic, prior-art laser-resonator 20, suitable for Q-switched operation. Resonator 20 includes a plane, maximum-reflecting mirror 22, and a concave output-coupling mirror 24, with a gain-medium 26 located adjacent the plane mirror. The mirrors and the gain-medium are aligned on a longitudinal axis 21 of the resonator. A Q-switch is not shown in the resonator for simplicity of illustration. Resonator 20 is in a hemi-confocal arrangement, with concave mirror 24 having a radius of curvature (ROC) R and mirrors 24 and 22 being physically, axially spaced apart by a distance about equal to R/2. The term “about”, as used in this instance, implies that the optimum physical spacing of the mirrors would depend on the optical length of the gain-medium, and the Q-switch (not shown).

Calculated pulse-delivery characteristics of an example of resonator 20 discussed below are used for comparison with pulse characteristics of a comparable arrangement of a laser-resonator in accordance with the present invention, also discussed below. It is assumed in the calculations that gain-medium 26 is pumped by an optical pump beam (not shown) delivered to the gain-medium along the longitudinal axis of the resonator (end-pumped). The optical pump beam is assumed to have a cross-section (transverse) intensity distribution I(x) which is a super-Gaussian distribution of order 5 (specifically I(x)=Exp[−x²*^{m}], where m=5). The cross-section intensity distribution of an oscillating mode (of the pulse beam) of the resonator is assumed to be Gaussian (specifically I(x)=Exp[−x²]). The 1/e² width of the pump-beam is assumed to be 300 micrometers (μm). The cold-cavity, 1/e² width of the mode is assumed to be 270 μm. The pump and mode intensity-distributions are indicated in FIG. 1 by dashed curves 27 and 29 respectively. It also assumed that the gain-medium is neodymium-doped yttrium vanadate (Nd:YVO₄), and that the pump-beam has a power of 20: Watts. The ROC (radius of curvature) R of mirror 24 is assumed to be 390 millimeters (mm) with a mirror spacing (cavity length) of 195 mm. The reflectivity of mirror 22 is assumed to be 100% and mirror 24 is assumed to have a reflectivity of 80% and a transmissivity of 20%. Pulse repetition frequency (PRF) is assumed to be 40 kilohertz (kHz).

FIG. 2 is a graph schematically illustrating calculated pulse-power characteristics (bold curve) and stored energy (fine curve) in the gain-medium as a function of time in prior-art laser-resonator 20, given the above discussed assumptions. The pulse has a duration (FWHM) of about 25 ns, a pulse energy of about 164 microjoules (μJ), a peak power of about 14 kilowatts (kW) and the average power in a 40 kHz sequence of the pulses is about 6.85 W. The resonator has a calculated build up time, i.e., the time required for a pulse to reach peak power after the Q-switch is opened in a fixedly aligned resonator, is about 52 ns. It can be seen that stored energy in the gain-medium is essentially completely depleted after the pulse is completed.

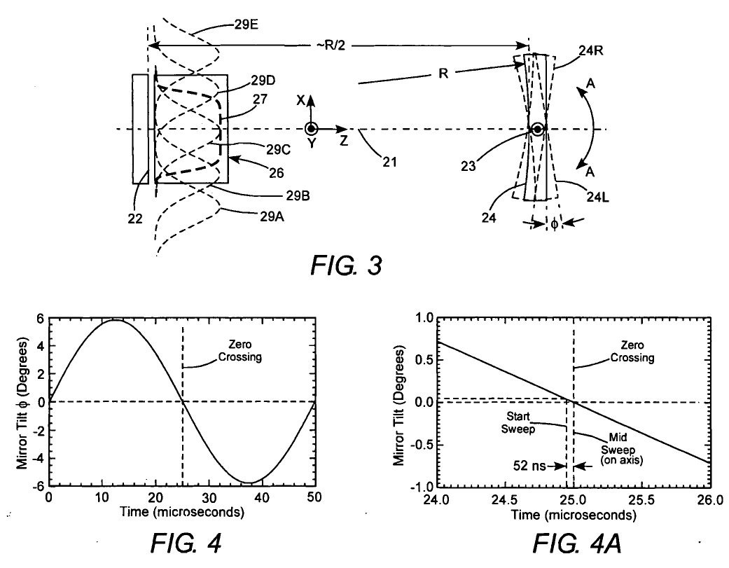

FIG. 3 schematically illustrates a basic embodiment 30 of a laser resonator in accordance with the present invention similar to the laser resonator of FIG. 1 in that the that gain-medium 26 is end-pumped by an optical pump beam delivered to the gain-medium along the longitudinal axis of the resonator (end-pumped), and having a cross-section intensity distribution I(x) which is a super-Gaussian of order 5, which creates an excited volume in the gain-medium having a diameter corresponding to about the 1/e² diameter of the optical pump beam. In laser 30, however, concave output-coupling mirror 24 thereof is periodically reciprocally tilted about an axis 23 (the Y-axis) transverse to the longitudinal (Z) axis of the laser resonator, through a range of angles about a position of perfect alignment (zero deflection) with the plane mirror. The periodic reciprocal motion (oscillation) of mirror 24 is indicated in FIG. 2 by arrows A. Extreme (maximum) tilt angle positions 24R and 24L of the mirror are designated in phantom, with the tilt angle being designated by the symbol ω, the tilt angle being, of course, a function of time. Gaussian curves 29A-E indicate sweeping of the lasing mode (pulse beam) through the pump-beam intensity distribution, i.e., through the excited volume of the gain-medium, under the oscillatory action of mirror 24. The sweep direction is in the X-axis (back and forth).

FIG. 4 is a graph schematically illustrating tilt angle as function of time for a full tilt period of the concave mirror of FIG. 3 (sinusoidal variation). The maximum tilt angles of ±5.76° and the period of oscillation of 50 μs (20 kHz oscillation frequency), corresponding to the above discussed resonator parameters are selected, such that the variation of tilt angle as a function of time through perfect alignment (zero crossing) will provide output pulses having the characteristics of the output pulse of FIG. 2 at the same repetition frequency. Detail of the zero crossing is depicted in the graph of FIG. 4A. It can be seen that in this limited range, variation of tilt angle with time can be considered as essentially linear Specifically, the maximum tilt angle is selected such that the time required for the mode to sweep from one edge of the pump beam to the centre (on axis), hereinafter referred to as the sweep time, is equal to the build up time for the prior-art resonator of FIG. 1, i.e., 52 ns in this example. The time required for the mode to sweep completely through the excited volume, of course is equal to twice the build-up period. Two pulses are triggered per oscillation period of the mirror, one pulse for each of the forward and reverse sweep directions. These are referred to hereinafter as the odd and even pulses.

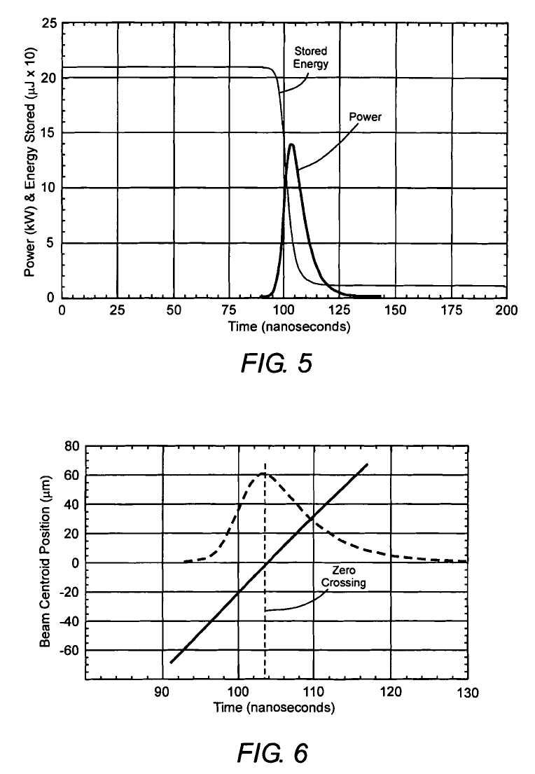

FIG. 5 is a graph schematically illustrating calculated pulse-power characteristics and stored energy in the gain-medium as a function of time in the inventive laser-resonator 30 of FIG. 3 in which the concave mirror is periodically reciprocally tilted under the optimized maximum tilt angle and oscillation frequency parameters of FIGS. 4 and 4A. The pulse has a duration (FWHM) of about 10 ns, a pulse energy of about 163 microjoules (μJ), a peak power of about 14 kilowatts (kW) and the average power in a 40 kHz sequence of the pulses is about 6.53 W. These characteristics are extremely close to the characteristics of the “baseline” pulses delivered by the prior-art resonator in which the mirrors are fixedly aligned.

FIG. 6 is a graph schematically illustrating calculated variation of the beam centroid position of the pulse of FIG. 5 (solid curve) as a function of time on the plane mirror of the resonator during evolution of the pulse (dotted curve). It can be seen that because of selecting the above-discussed sweep time to equal the build-up time of the resonator, the pulse reaches peak power when the beam centroid is on the longitudinal axis of the resonator. This then will be true for both odd and even pulses.

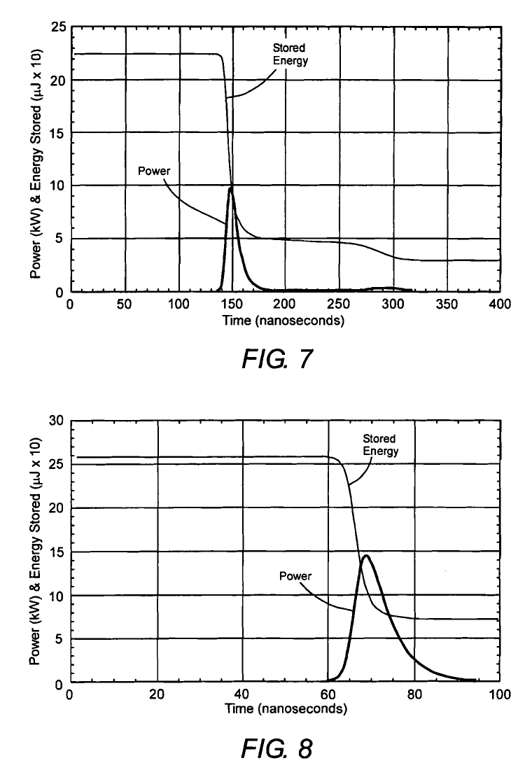

FIG. 7 is a graph schematically illustrating calculated pulse-power characteristics and stored energy in the gain-medium as a function of time in the inventive laser-resonator of FIG. 3 in which the concave mirror is periodically reciprocally tilted through one-half of the optimized maximum deflection angle of FIG. 4 at the same oscillation frequency. This causes the sweep time of the mode through the pump beam to be twice the above-discussed optimum time of 52 ns, i.e., 104 ns.

The pulse has a duration (FWHM) of about 12 ns, a pulse energy of about 158 microjoules (μJ), a peak power of about 9.7 kilowatts (kW) and the average power in a 40 kHz sequence of the pulses is about 6.33 W. A small, arguably useless, second lobe of the pulse occurs at a time slightly more than two sweep times after the initial useful pulse reaches peak power. About 13% of the initial stored energy remains in the gain-medium after the second lobe of the pulse is complete.

FIG. 8 is a graph schematically illustrating calculated pulse-power characteristics and stored energy in the gain-medium as a function of time in the inventive laser-resonator of FIG. 3 in which the concave mirror is periodically reciprocally tilted through twice the optimized maximum deflection angle of FIG. 4 at the same oscillation frequency. This causes the sweep time of the mode through the pump beam to be one-half the above-discussed optimum time of 52 ns, i.e., 26 ns.

In this instance, as might be expected energy extraction is even worse than in the case of the pulse of FIG. 7. About 27% of the initial stored energy remains in the gain-medium after the pulse is delivered.

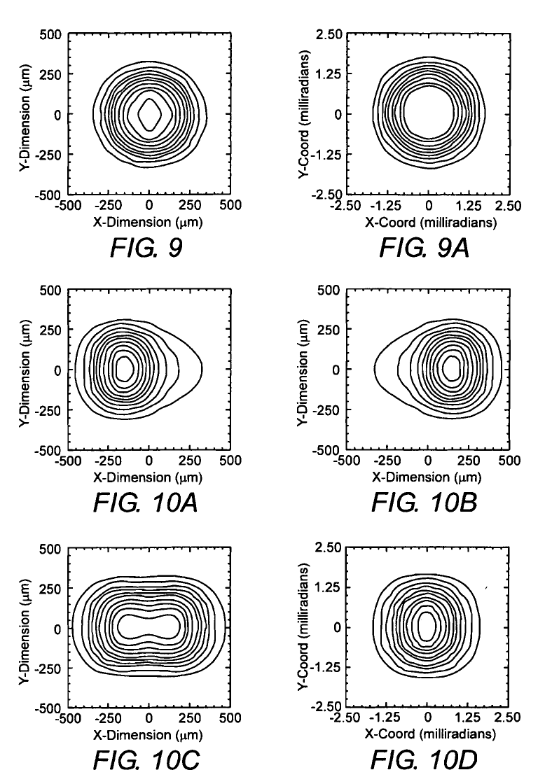

FIG. 9 is a contour graph schematically illustrating calculated intensity as a function of X and Y transverse-axis dimensions of the “optimized” pulse of FIG. 4 in the near-field of the beam, for example, at the plane mirror of resonator 30. Power contours are arbitrarily selected and not numerically identified, however, those skilled in the art will recognize that power increases from the outermost contour toward the innermost contour. As discussed, above peak power occurs when the beam centroid is on axis (X and Y=0.0) accordingly the contours for odd and even pulses, and accordingly, time averaged contours of a series of pulses, are essentially identical. The contours are nearly rotationally symmetrical in the near field. FIG. 9A is a contour graph schematically illustrating calculated intensity as a function of X-axis and Y-axis beam divergence angle of the pulse of FIG. 4 in the far-field of the beam. Here, it can be seen that the power contours in the far field are essentially rotationally symmetrical.

FIG. 10A is a contour graph schematically illustrating calculated intensity as a function of X-axis and Y-axis dimensions in the near-field of the beam for the pulse of FIG. 7 (slower than optimum sweep time) in one deflection direction of the concave mirror of FIG. 3. Here it can be seen that peak power occurs about 150 μm from (in front of) the axis in the sweep direction and the contours are definitely not rotationally symmetrical.

Calculated intensity as a function of X-axis and Y-axis dimensions in the near-field of the beam for the pulse of FIG. 7 in the opposite deflection direction of the concave mirror of FIG. 3 are depicted in the graph of FIG. 10B, here as might be expected, the peak power of the beam lies of opposite side of the axis and the contours are essentially the mirror image of the contours of FIG. 10A

Calculated time-averaged intensity as a function of X-axis and Y-axis dimensions in the near-field of the beam for a repeated sequence of (sequentially odd and even) pulses of FIG. 7 is depicted in the graph of FIG. 10C. These time-averaged contours have a somewhat “dumbbell” shape, elongated in the sweep direction of the beam. FIG. 10D is a graph schematically illustrating calculated time-averaged intensity as a function of X-axis and Y-axis beam divergence angles in the far-field of the beam for a repeated sequence of pulses of FIG. 7. It can be seen that the contours have lost the dumbbell shape and the X and Y dimensions are about equal.

In the case of the pulses of FIG. 8, the beam cross-section conditions are somewhat similar to those the pulses of FIG. 7 described above with an exception that, because of the faster than optimum sweep speed, peak power occurs behind the resonator axis in the sweep direction. These contours are not depicted herein for economy of illustration. However, again, of course, the peak power of the pulses occurs on opposite sides of the axis for odd and even pulses and the power contours of the odd and even pulses are essentially mirror images. Near-field, time-averaged contours are more dumbbell shaped than those depicted in the graph of FIG. 10C. Far-field, time-averaged contours have slightly unequal dimensions in the X and Y directions.

Qualitatively, the pulse cross-section characteristics, for the optimum sweep, “too slow” sweep, and “too-fast” sweep pulses, may be compared in terms of calculated M² values in the X and Y axis of the corresponding beams. The optimum sweep time resulted in M²_{X} and M²_{Y} of 1.42 and 1.38 respectively; the too-slow sweep time resulted in M²_{X} and M²_{Y} of 1.96 and 1.37 respectively; and the too-fast sweep time resulted in M²_{X} and M²_{Y} of 2.40 and 1.33 respectively. In the baseline resonator of FIG. 1 pulses would have M²_{X} and M²_{Y} about equal to 1.1. Acceptable performance of the Q-switched resonator may be obtained for sweep times between about 0.3 and 3.0 times the optimum sweep time, i.e., when the lasing mode is swept completely through the pump volume in a time period between about 0.6 and 6.0 times the resonator build-up time. Preferably, the sweep time is between about 0.5 and 2.0 times the optimum sweep time, i.e., the lasing mode is swept completely through the pump volume in a time period between about 1.0 and 4.0 times the resonator build-up time. Optimal performance, as noted above, is achieved when the resonator mode is swept completely through the pump volume in a time period equal to about 2.0 times (twice) the resonator build-up time.

It is useful at this stage of the instant description to summarize important operating parameters of the inventive laser. It is most preferable that the gain-medium be pumped by a beam of pump-light delivered along the longitudinal axis of the resonator, i e., end-pumped. Further, it is preferable that the pump light beam have a transverse (cross-section) intensity distribution that is as close as possible to a “flat topped” distribution. This can be approximated by a distribution which is a super-Gaussian of order 2 or greater, and more preferably of order 4 or greater. The 1/e² pump-beam diameter is preferably about equal to or slightly greater than the 1/e² diameter of the lasing mode of the resonator.

Further regarding optical pumping of the gain-medium, it is preferred that pump light be supplied from a multimode diode-laser or an array of such lasers with the light being delivered to the gain-medium via a multimode optical fiber. Passage of the light through the optical fiber homogenizes the light such that the light has about the preferred flat-topped distribution at the exit face of the optical fiber.

Regarding scanning or tilting of the reciprocally tiltable mirror, it is preferred that the angular excursion of the tilting on either side of the position of exact alignment is selected, cooperative with the tilting period of the mirror, such that the lasing mode is swept completely through (in and out of) the excited volume of the gain-medium, from one to an opposite edge, in a time period equal to about twice the build-up time of the laser resonator. The build-up time of the resonator is dependent, inter alia, on the material and dimensions of the gain-medium, resonator dimensions, and the percentage of outcoupling in the resonator, i.e., the transmission of the output coupling mirror.

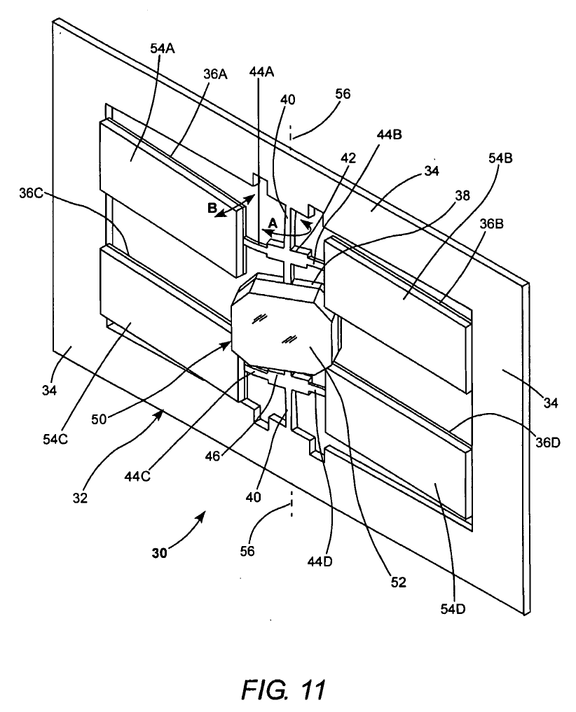

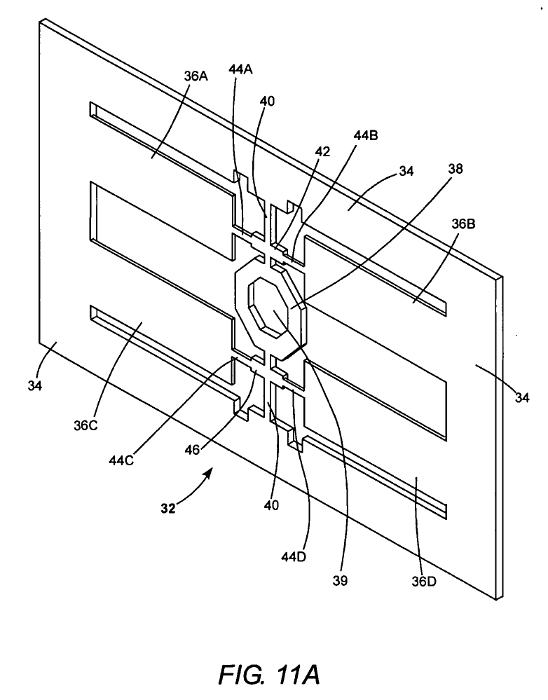

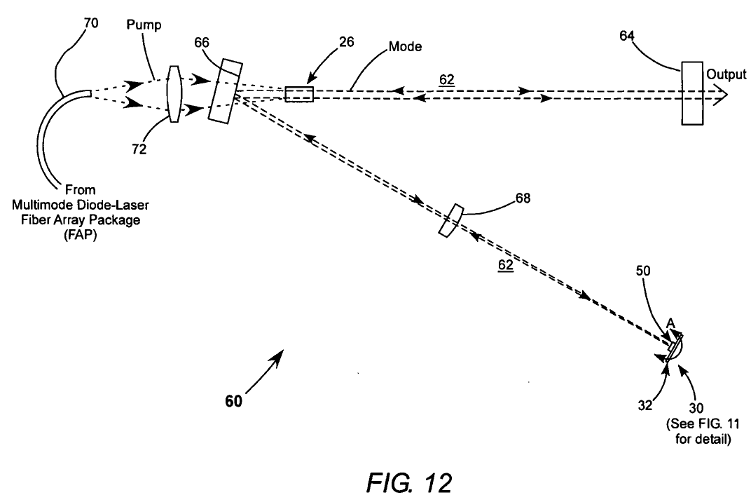

FIG. 11 and FIG. 11A, schematically illustrate a preferred embodiment 30 of a MEMS scanner device in accordance with the present invention, and designed to oscillate (periodically reciprocally tilt) a resonator mirror in the manner described above with reference to the hypothetical resonator of FIG. 3. Scanner 30 includes a support structure 32. As depicted in FIG. 11 A, structure 32 includes a rectangular frame portion 34, four actuator arms 36A, 36B, 36C, and 36D, and a mirror holder 38 on a torsion bar 40, which is connected to the frame. A distal end of each of the actuator arms is also attached to frame 34. A proximal end of each of actuator arms 36A and 36B is connected to torsion support beam 42 on the torsion bar by connecting-beams 44A and 44B respectively. A proximal end of each of actuator arms 36C and 36D is connected to torsion support beam 46 on the torsion bar by connecting-beams 44C and 44D respectively.

While the terms “attached” and “connected” are used above with respect to the actuator arms and connecting-beams, support structure 32 is preferably made by etching, in one or more stages, using photolithographic methods, a single metal sheet. In this way the, frame and other support structure components, and interconnections of the frame and those components, remain as a single integral unit when the etching is complete. In this example it is preferred that frame 32 be made by etching a 0.1 mm thick sheet of molybdenum. The outer dimensions of the surround are preferably about 8.0 millimeters (mm) long by about 5.0 mm high. Actuator arms 16 are preferably about 2.5 mm long by 1.0 mm high. Connecting beams 24 are preferably about 0.34 mm long by about 0.1 mm high. The actuator arms and the connecting beams are preferably thinned to about one-half of the thickness of the molybdenum sheet, i.e., to a thickness of about 0.05 mm.

Torsion bar 40 preferably has a length above the torsion support beams of about 0.63 mm and has a width of about 0.08 mm and a thickness of about 0.1 mm (the thickness of the sheet). Torsion support beams 46 preferably have a length of about 5.0 mm, a height of about 2.5 mm, and have the sheet-thickness of about 0.1 mm. The torsion bar between the torsion support beams and mirror holder 38 preferably has a length of about 0.32 mm. Mirror holder 38 is octagonal in shape and fits a surrounding square have a side of about 1.1 mm. The mirror holder also has the sheet thickness of about 0.1 mm. An optional aperture 39 in the mirror holder provides for a case where a transparent output coupling mirror is to be supported.

Referring in particular to FIG. 11, mounted on mirror holder 38 is a mirror 50 having a rectangular reflecting surface 52. The mirror in this example is modeled as a piece of silicon (Si), about 1.1 mm×1.1 mm×0.25 mm thick. This Si mirror is shown with an octagonal shape, but could be circular or rectangular or any other suitable shape, with the mirror holder 38 correspondingly configured. The mirror can be separately fabricated, for example from a larger sheet of material which may be coated with a suitable layer or layers of material to form a high reflectivity mirror, and sawn or etched to form the desired shape and size for use in this scanner. Preferably, the mirror is formed from a material with an expansion coefficient close to that of the supporting metallic frame in order to minimize temperature induced distortions of the mirror surface. Silicon is such a material. Additionally, a low-modulus adhesive can be used for bonding the mirror to mirror holder 38, to further minimize thermal bending between the mirror holder and the mirror.

Four piezoelectric elements 54A, 54B, 54C, and 54D, each about 2.5 mm long by about 1.0 mm high and having a thickness of about 0.1 mm are bonded to corresponding ones of actuator arms 36. Electrical connections to such piezoelectric elements are well-known in the art, and are not shown in FIG. 11 for simplicity of illustration. Separate electrical connections can be made to each piezoelectric element to allow different control voltages to be applied simultaneously to the piezoelectric elements. This is discussed further hereinbelow.

Regarding the selection of material for support structure 32, a number of metals are typically offered by vendors providing photo-etching services including a variety of types of stainless steels, copper, KOVAR, molybdenum, nickel, INVAR, aluminum, and titanium. Any of these may be suitable for a piezoelectric-driven scanner. Molybdenum is particularly suitable, however, due to its high thermal conductivity, high modulus, and a thermal expansion coefficient that matches well to typical piezoelectric materials and mirror substrate materials.

The piezoelectric elements can optionally be in either a bimorph or unimorph configuration. A bimorph configuration uses two oppositely-poled sheets of piezoelectric material, such that when a voltage is applied across the bimorph element, one side contracts while the other side expands, causing the bimorph to bend. The unimorph configuration uses a single sheet of piezoelectric material which will either contract or expand (depending on the material) when voltage is applied. In scanner 30, it is preferred that the piezoelectric elements are unimorphic and are referred to hereinafter, in the alternative, as piezoelectric unimorphs.

When the unimorph piezoelectric material is attached to another material, such as the molybdenum of actuator arms 36A-D, contraction or expansion of the piezoelectric material results in bending or deflection of the composite metal-unimorph structure. The relative thickness of the actuator arms and the piezoelectric elements is preferably chosen to optimize the force and deflection characteristics of the unimorph-metal combination. Similarly, the length and width of the torsion support beams 46 and the length of the coupler beams (44A-D) from the actuator arms to the torsion support beams can be adjusted to maximize the deflection (see arrow B) of the actuator arms at the proximal ends thereof. This deflection translates to angular deflection or tilting (see arrow A) of mirror-holder 38 and mirror 50 thereon about an axis 56 extending through torsion bar 40. In the operation of scanner A, equal, periodically and continually alternating (AC) potentials are applied to each unimorph 54, with the phase of the potentials applied to unimorphs 54A and 54C being the same, and 180° different from the phase of the potentials applied to unimorphs 54B and 54D. This assumes, of course, that the unimorphs are of the same material.

A scanner such as scanner 30 is preferably operated in a resonant mode. It is an important feature of the scanner that a resonant mode with an angular rotation about axis 56 and with a high Q can be utilized to achieve a high scan (tilt) angle q) by including mirror 50 as part of the resonant structure. It is a further feature of such a high-Q resonant scanner that there are regions near the supporting base of such a scanner where the displacement of the region is a small fraction of the translational or rotational displacement of the mirror. In the arrangement of actuator arms 36A-D and coupler beams 44A-C small displacements (deflections) of the actuator arms in the direction of arrow B can result in much larger rotation (tilting) of the scanning mirror in the direction of arrow A. Scanner 50 can be operated in both the fundamental torsional mode and at higher order torsional modes by varying the drive frequency of the scanner, i.e., by varying the frequency of the AC potentials applied to the piezoelectric unimorphs. This can be useful for some scanning applications. A scanner 50 having the parameters discussed above has one resonant frequency at 19.5 kHz (close to the 20 kHz of the calculated examples discussed above) and another resonant frequency at 32.3 kHz.

There are substantial advantages to having resonant actuation of a scanner such as scanner 50, but it would also convenient or possibly may even be necessary to be able to control the frequency of the scanner. Simply varying the AC drive-frequency is not preferred, as a drive-frequency away from the natural resonance frequency will not result in the maximum rotational angle in the direction of arrow A. Preferably the frequency of applied AC potentials is about equal to the frequency of the desired resonant mode. There are two convenient ways to adjust the resonant frequency of such a scanner. In some cases it may only be necessary to adjust for manufacturing tolerances, in which case it is possible to adjust the mass of the optical element being moved by the device, here, mirror 50. This can be done by adding mass to the mirror, for example by applying a UV-curing adhesive to the mirror and curing the adhesive. This can be done with automation during manufacturing. If it is required to vary the operating frequency over a small range during operation, it is possible to use piezoelectric elements to increase the tension in one or more of the support members in the scanner. This raises the resonant frequency of the structure in the same way that a piano is tuned by changing the tension in the string. By way of example, either additional piezoelectric elements can be arranged near the base of the moving structure, i.e., in the region where actuator arms 36 are attached to the frame, or the existing drive elements (piezoelectric unimorphs) 54A-D can be DC-biased to stress the support arms 36A-D as an AC drive-signal is superimposed to drive the mirror into resonance.

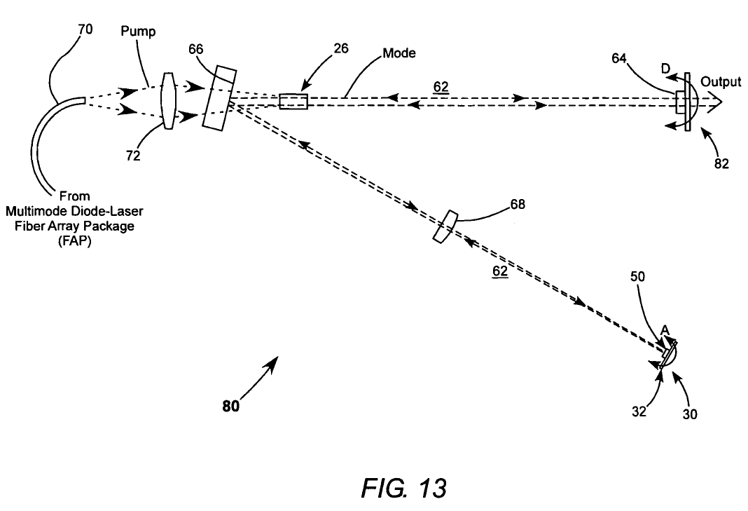

Continuing now with a description of a practical laser incorporating the above described mirror scanner of FIGS. 11 and 11A, FIG. 12 schematically illustrates a preferred embodiment 60 of an experimental Q-switched, pulsed laser in accordance with the present invention including a two-arm folded laser resonator 62. Resonator 62 is terminated by plane mirror 50 mounted on the above-described scanner 30 and by another plane mirror 64. Resonator 62 is “folded” by yet another plane mirror 66. A positive lens 68 is located in the resonator between mirror 50 and fold mirror 66. Gain-medium 26 is included in the resonator between mirror 64 and fold mirror 66, relatively close to the fold mirror.

Gain-medium 26 in this example is a 0.7% neodymium-doped, yttrium orthovanadate (Nd:YVO₄) rod having a length of about 7 mm. The rod is optically pumped by 20 W of 810 nm-wavelength light from a diode-laser-bar fiber array package (FAP) delivered by a multimode optical fiber 70 having a diameter of about 600 micrometers (μm). The package including a plurality of multimode diode-laser bars is not explicitly depicted. Such packages are commercially available from Coherent Inc, of Santa Clara, Calif., and a detailed description of such a package is not necessary for understanding principles of the present invention.

Mirror 66 has maximum reflectivity, for example greater than 99% reflectivity, for 1064 nm radiation (the fundamental wavelength of the Nd:YVO₄ gain-medium), and has maximum transmission, for example greater than 90% transmission, for the 810 nm-wavelength pump-light. Transmission through the multimode fiber homogenizes the intensity distribution of the pump light at the delivery end of the optical fiber such that focused pump-light in the gain-medium closely approximates the high-order super-Gaussian distribution of pump light used in theoretical calculations discussed above with reference to the hypothetical resonator of FIG. 3. Mirror 50 has maximum reflectivity at a wavelength of 1064 nm. Mirror 64 has about 70% reflectivity and about 30% transmission at a wavelength of 1064 nm.

Regarding dimensions of the resonator, gain-medium 26 is located with one face thereof at about 97 mm from mirror 64 and the opposite face thereof at about 17 mm from fold mirror 66. Lens 68 is a piano-convex lens having a focal length of about 91 mm. The lens is located with the convex surface thereof at about 75 mm from mirror 50 and with the plane surface thereof at about 77 mm from fold mirror 66.

Mirror 50 and support structure 32 of scanner 30 have about the dimensions discussed above with reference to scanner 30 of FIGS. 11 and 11A. The scanner reciprocally tilts mirror 50 by ±5° about an axis perpendicular to the resonator axis at a frequency of about 20 kHz.

In many pulsed-laser applications it is necessary to be able to deliver laser radiation in temporally spaced-apart bursts of Q-switched pulses, or even in variably temporally spaced individual Q-switched pulses. FIG. 13 schematically illustrates another preferred embodiment 80 of a laser in accordance with the present invention, wherein burst-mode or individual pulse operation is possible. Laser 80 is similar to laser 60 of FIG. 12 with an exception that output coupling mirror 64 is reduced in dimensions and is digitally or discretely tiltable about an axis perpendicular to the resonator axis as indicated by arrows D. In FIG. 13, mirror 64 is depicted as being tiltable by a scanner 82 similar to above described scanner 30 but enlarged to accommodate a larger mirror. It should be noted, however, that mirror 64 does not have a Q-switch function and needs only to be rapidly switched from an orientation in which pulses can be generated in the resonator as mirror 50 is periodically tilted to an orientation in which pulses can not be generated in the resonator in any orientation of mirror 50. This requires a change in alignment of only a few milliradians. Scanner 82 will not be operated in a resonant mode, and will preferably by driven by application of digitally switched potentials., i.e., potentials that are switched essentially instantaneously from zero to some predetermined positive or negative value. Scanner 82, accordingly, may be replaced by any other prior-art mirror-moving device such as a galvanometer scanner, without departing from the spirit and scope of the present invention.

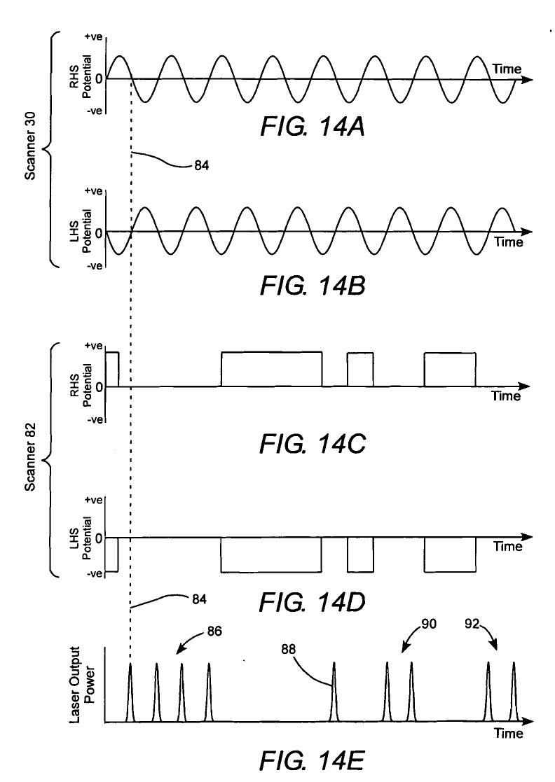

FIGS. 14A-E are timing-diagram graphs schematically illustrating an example of an operation mode of laser 80. Here it is assumed that scanner 82 is of the same design as above described scanner 30 and is tilted by four actuator arms, i.e., right hand side (RHS) and left hand side (LHS) pairs of arm. In mirror 30, 180°-out-of phase AC potentials are applied to the RHS and LHS pairs of arm. In scanner 82 DC potentials are digitally switched to the pairs of actuator arms. Mirror 64 of scanner 80 is aligned when there are no DC potentials applied to the scanner, and laser pulses are generated at the zero-crossings of the applied AC potentials as indicated by dashed line 84. Mirror 64 is completely misaligned when the DC potentials are applied to scanner 82 and no pulses can be generated, whatever the sweep position of mirror 50. FIG. 14E illustrates laser output as a burst 86 of four pulses, a single pulse 88 generated after pulse repetition intervals following pulse-burst 66, and bursts 90 and 92 of two pulses.

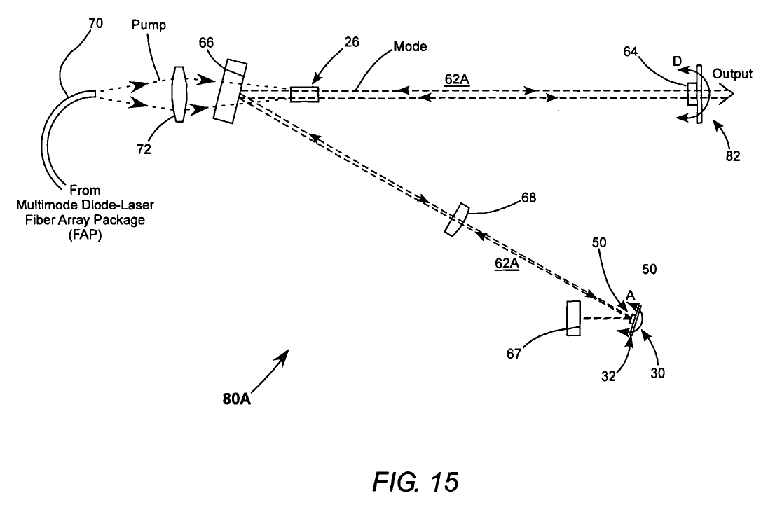

FIG. 15 schematically illustrates yet another embodiment 80A of a laser in accordance with the present invention, wherein burst-mode or individual pulse operation is possible. Laser 80A is similar to laser 80 of FIG. 13 with an exception that resonator 62A of laser 80 is terminated by mirror 64 of a scanner 82 and a separate end mirror 67. Resonator 62A is twice-folded. One fold is provided by mirror 66 through which pump light is delivered along the longitudinal axis of the resonator, and the other fold is provided by mirror 50 in scanner 30, which provides the Q-switch function as described above. This demonstrates that Q-switching by a scanning mirror is not limited to periodically reciprocally tilting an end mirror of a laser resonator. A multiply folded resonator can be useful in shortening overall dimensions of a laser in accordance with the present invention, albeit at the cost of an increased component count.

Another property of resonator 62A is that the placement of mirror 50 creates an angular excursion of the lasing mode in the gain medium that is twice that of the angular excursion of the mirror, as the mode is essentially tilted twice mirror 50. This provides that a given sweep velocity can be obtained with only half of the angular excursion of mirror 50 that would be required in above-described embodiments of the inventive laser.

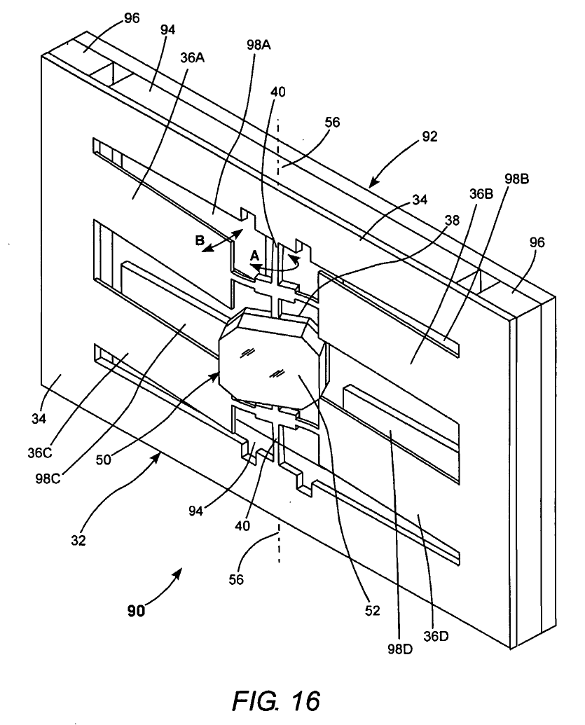

In the above presented description, the inventive scanners are described as being activated by piezoelectric elements attached directly to actuator arms. The inventive scanners are not limited, however, to this preferred type of piezoelectric drive, and may be electrostatically or magnetically drive. By way of example FIG. 16 schematically illustrates a scanner 90, similar to scanner 30 of FIG. 3, but wherein actuator arms 36A-D are electrostatically deflected. Scanner 90 includes a mirror support structure 32 including actuator arms 36A-D as described above with reference to scanner 30 of FIG. 11. Scanner 90 includes a backing plate 92 of an insulating material such as alumina. Backing plate 92 is spaced apart from support structure 32 by horizontal and vertical spacer strips 94 and 96 respectively, disposed around the periphery of the support structure. Attached to backing plate 92 in positions corresponding to the positions of actuator arms 36A-D are elongated electrodes 98A-D to which alternating AC potentials can be applied. Electrostatic attraction between the electrodes and the actuator arms serves to deflect the actuator arms as indicated by arrow B, creating corresponding angular rotation of mirror 50 as indicated by arrow A.

Those skilled in the art will recognize without further illustration that a scanner such as scanner 30 may be magnetically driven rather than electrostatically driven. By way of example this could be accomplished in a scanner similar to scanner 90 by replacing electrodes 98A-E with similarly shaped poles of AC driven electromagnets. In such a magnetically driven scanner, however, it would be necessary to form support structure 32 from a magnetically susceptible, etchable material, for example, silicon steel.

An advantage of the inventive scanner, however driven, is that the scanner lends itself to high-volume, low-cost fabrication by photolithographic methods. It can be difficult, expensive, or even impractical to try to form a scanner directly from a piezoelectric material such as PZT. Piezoelectric materials are often brittle ceramic materials that are easily broken. Thus it is advantageous to use a metallic structural layer such as support structure 32 of scanner 30 to support piezoelectric elements. Such support structures can readily be generated in volume. One method of forming such structures is to lithographically define features of a plurality of the structures in a regular pattern on a metallic sheet and then etch the metallic sheet to form a plurality of individual structures. Commercial vendors are available to do this in high volume at low cost. A variety of metals and alloys may be used, such as stainless steel, beryllium copper, and molybdenum. Sheets up to 11″×17″ in size are commonly used. This could provide as many as 2500 scanners in the 5.0 mm×8.0 mm size exemplified above.

The individual substrates may be attached to each other in the sheet and to a fabrication support frame by small tabs. The tabs can be broken off to singulate the structures. It is also possible to etch the structures free of each other during the etching process. It can be convenient, however, to keep them attached to a support frame, as it may be necessary to plate or deposit thin metal layers on the surface of the metallic support structures to allow the soldering of the piezoelectric elements to the actuator arms of the support structures.

In the case of a scanner 30 wherein the support structure 32 is molybdenum and has dimensions discussed above, the structures are formed in a molybdenum sheet having a thickness of about 0.1 mm. A layer of nickel is plated onto the etched molybdenum sheet and gold is subsequently plated onto the nickel layer to facilitate subsequent soldering. Sheet piezoelectric material, such as commercially available metalized PZT material having a thickness of about 0.005″ (about 125 μm) is first sawn into rectangular pieces, in this example 1 mm×2.5 mm. The rectangular PZT pieces are then soldered to the actuator arm portions of the plated molybdenum support structures. Wires are attached to the exposed surface of the PZT pieces for making electrical connection thereto, for example, by soldering. The plurality of scanner assemblies so formed can then be attached to thicker support frames, to allow ease in handling of the scanner assemblies. A mirror 50, can be attached to mirror support member 38 of each of the scanner assemblies, either by soldering or by adhesives. Complete scanners can then be singulated at different stages in the process, depending on whether the parts are assembled in a multi-up format or individually. Generally it is convenient to have the layout of the parts on the sheet material match assembly tooling, for example, if 10 parts are to be assembled at a time, 10 parts can be arranged, for example in one or two rows, with an etched frame to hold them during assembly.

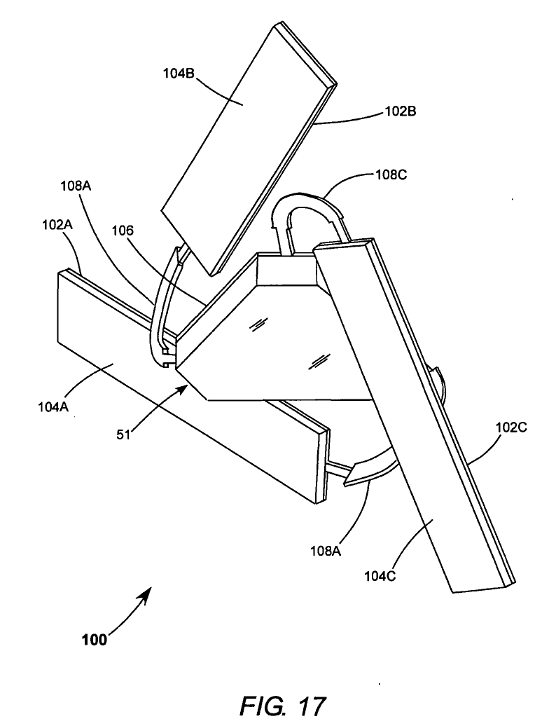

In the description of the present invention presented above, the inventive optical element scanners are designed to provide only periodic reciprocal tilting or rotation of an optical element, such as a mirror, about a single rotation axis. Principles of the inventive scanner may be applied however to forming a scanner that can move an optical element with two or more degrees of freedom By way of example FIG. 17 schematically illustrates a micromechanical scanner 100 in accordance with the present invention arranged to move an optical element 51 (here, a mirror) with three degrees of freedom. Such mirror movement including tilting the mirror about two mutually perpendicular axes can be used, for example, in arrangements to control pointing of a laser beam.

Scanner 100, includes three elongated actuator arms 102A, 102B, and 102C, to which elongated piezoelectric elements 104A, 104B, and 104C respectively are attached. Distal ends of the actuator arms are attached to a support frame (not shown) Proximal ends of actuator arms 102A, 102B and 102C are attached to a triangular mirror holder 106 by U-shaped coupler beams 108A, 108B, and 108C, Triangular mirror 51 is attached to mirror holder 106.

By separately adjusting the individual actuator arms by separate potentials applied to the piezoelectric elements, mirror 51 can be tilted about any arbitrary in-plane axis, and or the vertical position of the mirror can be adjusted in a piston-like manner. The particular mode of scanner 100 depicted in FIG. 17 has a resonant frequency of about 12.5 kHz. It can be seen that right-hand actuator 102C is basically not deflected, while the upper-left hand actuator 102B is deflected upwards and the lower-left hand actuator 102A is deflected down.

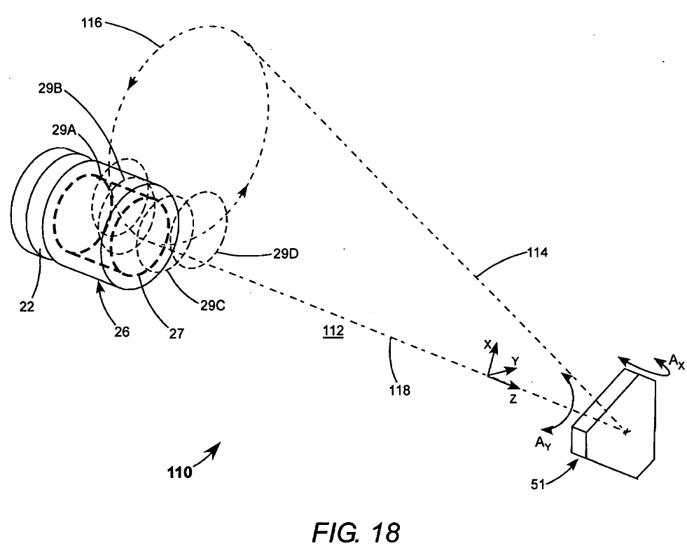

FIG. 18 schematically illustrates another basic embodiment 100 of a Q-switched pulsed laser in accordance with the present invention, similar to the laser of FIG. 3, but wherein the reciprocally tilted mirror is replaced by a mirror 51 tiltable in two mutually perpendicular axis such that the axis of the mirror. Mirror 51 when correctly aligned forms a resonator 112 of laser 100. Here mirror 51 is reciprocally tilted about the transverse X-axis of resonator 112 as indicated by arrows Ax, while being reciprocally tilted about the transverse Y-axis of resonator 112 as indicated by arrows Ay. Tilting the mirror can be accomplished, for example, by the inventive scanner arrangement 100 described above with reference to FIG. 17.

The reciprocal tilting is arranged such that the optical axis 114 of mirror 51, remote from the mirror, describes a closed loop path 116. Path 116 is depicted in the form of a circle but could also have an elliptical form. This would occur when scanning in Ax and Ay at the same frequency but 90° out-of-phase, with the magnitude of the sweeps in each axis determining the degree of ellipticity. The tilting of mirror 51 is also arranged such that path 116 intersects the longitudinal axis 118 of the resonator at which point the resonator mirrors will be exactly aligned, and the resonator mode will fill the pumped volume 27 of gain medium 26. The resonator mode will sweep through the pumped volume once for every revolution or circuit of the mirror axis around closed loop 116, as indicated by direction arrows on the loop and by dashed circles 29A, 29B, 29C, and 29D. This will provide a Q-switching action similar to that provided by the above-described, one-axis reciprocally tiltable mirror, with an exception that the mode-sweep though the pump-volume, for a circular or elliptical closed loop, will occur only once per circuit of the loop, and will always occur in the same direction.

Scanning Ax at twice the frequency of Ay could produce a closed loop in the form of a figure-of-eight. This could provide either one or two mode-sweeps through the pump-volume, depending on the placement of the closed loop with respect to the resonator axis. Scanning A_{X} and A_{Y} at the same frequency and amplitude, in phase, would produce a reciprocal scan along a line at 45 to the X and Y axes.

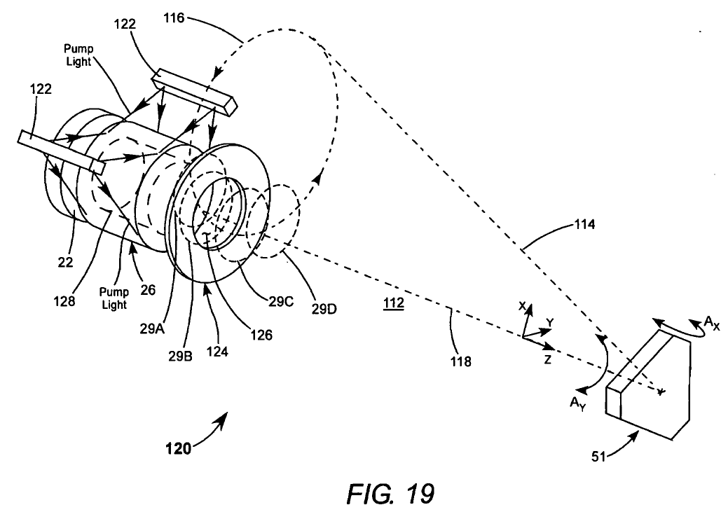

Laser 110 and other embodiments of the inventive Q-switched laser described above employ an ended-pumped gain-medium. End-pumping is preferred because it is capable of providing a pumped volume in the gain-medium that has a symmetrical energy distribution and, when, in a high-order super-Gaussian form can have a uniform energy distribution across the boundary. The inventive Q-switching method can practiced with a transversely-pumped (side-pumped) gain-medium but steps must be take to avoid any problem created by transversely-extended and non-uniform pump volumes commonly associated with side-pumping. A description of the inventive-Q-switching method applied to a side-pumped gain medium is set forth below with reference to FIG. 19.

Here, yet another basic embodiment 120 of a Q-switched pulsed laser in accordance with the present invention is similar to the laser 110 of FIG. 18, with an exception that gain-medium 26 is side-pumped by light delivered from a plurality of diode-laser bars 122. Only two bars 122 are depicted here for simplicity of illustration. In this type of pumping arrangement, the entire volume of the gain medium is usually pumped, and energy distribution particularly near the edges of the gain medium is non uniform. Those skilled in the art will recognize that a solid state gain-medium such as a Nd:YVO₄ crystal typically has a width of at least 2 or 3 mm, while the mode-size of a short resonator may be no more than a few hundred micrometers. In laser 120, a blocking disc 124 is included in resonator 112. Disc 124 has a circular aperture 126 therein, centered on resonator axis 118 and having a diameter about equal to the mode diameter at that location in the resonator. The diameter of the disc is made sufficient that a lasing mode only has access to the gain medium via aperture 126 therein so that in the perfect alignment position, when loop 116 intersects the resonator axis, the lasing mode has access to a portion of the energized volume of the gain-medium having a diameter about the same as that of the lasing mode. This portion of the energized volume is cylindrical and is indicated in FIG. 19 by long-dashed lines 128. This makes the Q-switching effectiveness about the same as that obtainable in end-pumped embodiments of the inventive laser described above. The use of pump light energy however is less efficient in side-pumped laser 120.

In summary, a Q-switched pulsed laser in accordance with the present invention is described above, wherein Q-switching is effected by rapidly and reciprocally tilting a resonator mirror about an axis perpendicular to the resonator axis. The angular excursion of the tilting and the frequency of the tilting are selected cooperative with dimensions of the resonator to maximize energy and symmetry of intensity distribution in Q-switched pulses delivered by the laser. In preferred embodiments of the inventive laser, rapid reciprocal tilting of the mirror is accomplished using an inventive, miniature, piezoelectrically-driven, mechanical scanner operated in a resonant mode. It should be noted, however, that while the present invention is described above in terms of preferred and other embodiments, the invention is not limited to the embodiments described and depicted. Rather, the invention is limited only by the claims appended hereto.

What is claimed is:

1. A laser, comprising:
a laser resonator, the laser resonator having a longitudinal axis and a resonator mode;
a solid-state gain-medium located in the laser resonator and having a fundamental lasing wavelength;
an arrangement for optically pumping the gain-medium with a beam of pump-light delivered thereto along the longitudinal axis of the laser resonator thereby creating an excited volume in the gain-medium; and
wherein the laser resonator includes a mirror located on the longitudinal axis of the laser resonator and periodically reciprocally tiltable about an axis transverse thereto in a manner such that the resonator mode is swept through the excited volume in the gain-medium twice during a tilt period of the mirror.

2. The laser of claim 1, wherein the reciprocally tiltable mirror is the first of first and second mirrors terminating said laser resonator.

3. The laser of claim 2, wherein the first mirror has maximum reflectivity at the lasing wavelength, and the second mirror is partially reflective and partially transparent at the lasing wavelength.

4. The laser of claim 2, wherein the second mirror has maximum reflectivity at lasing wavelength, and the first mirror is partially reflective and partially transparent at the lasing wavelength.

5. The laser of claim 1, wherein the laser resonator has a pulse build-up time and the resonator mode sweeps completely through the excited volume of the gain-medium in a time period between about 0.6 times the pulse build-up time and about 6.0 times the pulse build-up time.

6. The laser of claim 5, wherein the laser resonator has a pulse build-up time and the resonator mode sweeps completely through the excited volume of the gain-medium in a time period between about 1.0 times the pulse build-up time and about 4.0 times the pulse build-up time.

7. The laser of claim 6, wherein the resonator mode sweeps completely through the excited volume of the gain-medium in a time period equal to about twice the pulse build-up time.

8. The laser of claim 1, wherein the pump-light beam has about a flat-topped transverse energy distribution.

9. The laser of claim 8, wherein the pump-light beam has a transverse energy distribution that is about a super-Gaussian distribution of order two or greater.

10. The laser of claim 9, wherein the pump-light beam has a transverse energy distribution that is about a super-Gaussian distribution of order four or greater.

11. The laser of claim 8, wherein the pump light is supplied by one of a multimode diode-laser and a plurality of multimode diode lasers and is delivered to the gain-medium via a multimode optical fiber.

12. The laser of claim 1, wherein a laser pulse is generated by the laser resonator with each sweep of the resonator mode through the excited volume of the gain-medium.

13. The laser of claim 1, further including a second mirror located on the resonator axis and the second mirror being digitally tiltable from a first orientation in which a laser pulse is generated by the laser resonator with each sweep of the resonator mode through the excited volume of the gain-medium to a second orientation which prevents generation of a pulse with a sweep of the resonator mode through the excited volume of the gain-medium.

14. The laser of claim 13, wherein the periodically reciprocally tiltable mirror and the digitally tiltable second mirror are end mirrors of the laser resonator.

15. The laser of claim 1, wherein the mirror is periodically reciprocally tilted by a MEMS device.

16. The laser of claim 15, wherein the MEMS device includes a plurality of elongated actuator arms each thereof having a first end thereof fixed and an opposite second end thereof attached via a coupling member to a torsion bar to which a mirror holder is attached, with the mirror being attached to the mirror holder, the second ends of the actuator arms being periodically deflectable by one of electrical or magnetic means, and the actuator arms torsion bar and coupling members being configured such that the periodic deflection of the actuator arms causes the periodic tilting of the mirror.

17. The laser of claim 16, wherein the second ends of the actuator arms are periodically deflected by electrical means.

18. The laser of claim 17, wherein the second end of each actuator arm is periodically deflected periodically by a piezoelectric element attached to the actuator arm and activated by alternating potential applied thereto.

19. The laser of claim 18, wherein there are first and pairs of actuator arms attached to opposite sides of the torsion bar, wherein the alternating potential applied to piezoelectric elements on the first pair of actuator arms is 180° out-of-phase with the alternating potential applied to piezoelectric elements on the second pair of actuator arms.

20. The laser of claim 16, wherein said MEMS device is driven by an alternating electric potential having a frequency about equal to a resonant frequency of the MEMS device.

21. A laser, comprising:
a laser resonator, the laser resonator having a longitudinal axis and a resonator mode;
a solid-state gain-medium located in the laser resonator and having a fundamental lasing wavelength;
an arrangement for optically pumping the gain-medium with a beam of pump-light delivered thereto along the longitudinal axis of the laser resonator thereby creating an excited volume in the gain-medium; and
wherein the laser resonator includes a mirror located on the longitudinal axis of the laser resonator and periodically reciprocally tiltable about first and second mutually perpendicular axes transverse thereto in a manner such that the resonator mode is swept through the excited volume in the gain-medium at least once during a tilt period of the mirror about any one of the axes.

22. The laser of claim 21, wherein the mirror is periodically reciprocally tilted about each of the transverse axes at the same frequency, with the tilting about the first axis being 90 degrees out-of-phase with the tilting about the second axis, such that the resonator mode is swept through the excited volume in the gain-medium only once during a tilt period of the mirror.

23. The laser of claim 21, wherein the mirror is periodically reciprocally tilted about each of the transverse axes at the same frequency, with the tilting about the first axis being 90 degrees out-of-phase with the tilting about the second axis, such that the resonator mode is swept through the excited volume in the gain-medium only once during a tilt period of the mirror.

24. The laser of claim 21, wherein the laser resonator has a pulse build-up time and the resonator mode sweeps completely through the excited volume of the gain-medium in a time period between about 0.6 times the pulse build-up time and about 6.0 times the pulse build-up time.

25. The laser of claim 24, wherein the laser resonator has a pulse build-up time and the resonator mode sweeps completely through the excited volume of the gain-medium in a time period between about 1.0 times the pulse build-up time and about 4.0 times the pulse build-up time.

26. The laser of claim 25, wherein the resonator mode sweeps completely through the excited volume of the gain-medium in a time period equal to about twice the pulse build-up time.

27. The laser of claim 21, wherein the pump-light beam has about a flat-topped transverse energy distribution.

28. The laser of claim 27, wherein the pump-light beam has a transverse energy distribution that is about a super-Gaussian distribution of order two or greater.

29. A laser, comprising:
a laser resonator, the laser resonator having a longitudinal axis and a resonator mode;
a solid-state gain-medium located in the laser resonator and having a fundamental lasing wavelength;
an arrangement for optically pumping the gain-medium with pump-light delivered thereto in a direction transverse to the longitudinal axis of the laser resonator thereby creating an excited volume in the gain-medium;
a restricting member located in the resonator said restricting member having an aperture therein located on the longitudinal axis of the resonator and restricting the access of the resonator mode to a predetermined portion of the excited volume of the gain-medium; and
wherein the laser resonator includes a mirror located on the longitudinal axis of the laser resonator and periodically reciprocally tiltable about at least one axis transverse thereto in a manner such that the resonator mode is swept through the predetermined portion of the excited volume in the gain-medium at least once during a tilt period of the mirror about said at least one axis.

30. The laser of claim 29, wherein the aperture in the blocking member is circular, and the predetermined portion of the excited volume is cylindrical.

31. A laser comprising:
a laser resonator including at least two end mirrors;
a gain medium located within the resonator;
means for pumping the gain medium; and
a mount for one of said end mirrors, said mount including a torsion member operatively connected to a pair of piezoelectric driven elements, said piezoelectric driven elements being actuated in response to AC potentials delivered thereto in a manner to cause said one mirror to reciprocally tilt and cause the laser to generate a Q-switched output.

32. The laser of claim 31, wherein the mount is configured such that a resonator mode of the laser is swept through an excited volume in the gain medium twice during a tilt period of the mirror.
